(19) United States
(12) Patent Application Publication
(10) Pub. No.: US 2016/0331643 A1
(43) Pub. Date: Nov. 17, 2016

(54) INTELLIGENT EXTENSION MEDICINE BOX SYSTEM

(71) Applicant: INFOENGINE TECHNOLOGY (SHENZHEN) LIMITED, Shenzhen City (CN)

(72) Inventors: Wencong Chen, Shenzhen City (CN); Feng Zhou, Shenzhen City (CN)

(21) Appl. No.: 15/111,308

(22) PCT Filed: Jan. 19, 2015
(86) PCT No.: PCT/CN2015/071011

§ 371 Date: Jul. 13, 2016

(30) Foreign Application Priority Data
Jan. 24, 2014 (CN) 201410033471.2

(51) Int. Cl. A61J 7/04; A61J 7/00

(52) U.S. Cl. CPC A61J 7/0454; A61J 7/0076; A61J 7/0481; A61J 2200/70; A61J 2200/30; A61J 2205/60

(57) ABSTRACT

An intelligent extension medicine box system, including a main control box and more than one sub-medicine box is provided. A main controller is arranged in the main control box, wherein a main connector is arranged on one side of the main control box. The sub-medicine box is formed by a box body and a box cover, wherein the inner part of the box body is divided into a medicine storage chamber and a sub-control chamber from top to bottom. A medicine bin with an inverted semi-conical bottom is arranged in the medicine storage chamber, wherein a medicine box light-emitting device and a detection device are arranged on the bottom of the medicine bin. A left connector and a right connector are arranged at the two sides of the sub-control chamber, wherein the left connector can be connected to the main control box or the right connectors of other sub-medicine boxes through the main connector.

### CROSS-REFERENCE TO RELATED APPLICATIONS

This application claims priority to PCT Application No. PCT/CN2015/071011, having a filing date of Jan. 19, 2015, based off of Chinese Application No. 201410033471.2, having a filing date of Jan. 24, 2014 the entire contents of which are hereby incorporated by reference.

### FIELD OF TECHNOLOGY

The following relates generally to the field of intelligent medical treatment and healthcare using Internet of Things, in particular to an intelligent medicine box with timing, prompting and medicine-taken monitoring functions and dynamically connectable and detachable sub-medicine boxes.

### BACKGROUND

So far, a well-known electronic medicine box has a limited number of undetachable medicine bins, however different medicines and medicine-taking time might require more or fewer medicine bins inside the box when a user uses the medicine box. The user has to take out the entire medicine box even they don't need all the medicine bins for their medicines; or in some cases, the user may buy another medicine box if the medicine bins are unmatched with their needs. Both caused inconvenience for users.

Some conventional medicine boxes however are connectable and are detachable into several sub-medicine boxes, they have no functions such as timing, prompting, medicine-taken monitoring that electronic medicine boxes have, and this also caused inconvenience for users. The following aims to provide an intelligent extension medicine box system that is freely connectable and detachable.

### SUMMARY

An aspect relates to an intelligent extension medicine box system including a main control box and more than one sub-medicine box. A main controller is arranged in the main control box, wherein a main connector is arranged on one side of the main control box, and the main controller is connected with the main connector. The sub-medicine box includes of a box body and a box cover, wherein the inner part of the box body is divided into a medicine storage chamber and a sub-control chamber from top to bottom. A medicine bin with an inverted semi-conical bottom is arranged in the medicine storage chamber, wherein a medicine box light-emitting device and a detection device are arranged on the bottom of the medicine bin, and the detection device is used for detecting the medicine state in the medicine bin. A left connector and a right connector are arranged at the two sides of the sub-control chamber, wherein the left connector can be connected to the main control box or the right connectors of other sub-medicine boxes through the main connector. A sub-controller is arranged in the sub-control chamber, and can control the detection device and the medicine box light-emitting device and transmit information of the detection device that analyzed to the main controller as connected with the main connector through the sub-connector.

The main controller is integrated with a central control chip, a radio transmitter, a clock chip, and a connection detector. A sound maker, a vibrator, a control box light-emitting device, and a position balance sensor are arranged in the main control box. Control keys are arranged on the upper surface of the main control box;
wherein the central control chip receives instruction from an intelligent terminal after connected with the intelligent terminal through the radio transmitter and controls the sound maker, the vibrator, and the control box light-emitting device as instructed. The states inside the medicine box that analyzed are transmitted to the intelligent terminal through the radio transmitter;
the radio transmitter is used for connecting the medicine box with the intelligent terminal using radio data transmission. The medicine box can be connected with the intelligent terminal and bound with the device through radio WiFi data transmission or Bluetooth;
the real-time clock chip as the major timing and prompting device has its time in sync with current time and medicine-taking prompting time of the intelligent terminal, and can independently keep timing to help the medicine box control chip remind users;
the connection detector is used for detecting if there are sub-medicine boxes connected with the medicine box;
the sound maker, in the form of a sound-making buzzer, is used for making sound to remind users of taking medicine at a specified time or to remind users as wireless connection is off; the vibrator is used for reminding users of taking medicine at a preset time or prompting when wireless connection is disconnected through vibration;
the control box light-emitting device, in the form of a light emitting diode, is used for indicating connection and disconnection states of wireless connection and prompting users of low battery or replacement or charging the battery;
the position balance sensor is used for sensing whether the medicine box is flatwise or not and transmitting to the controller in the medicine box, so as to check medicine and content;
the control keys are input devices used for confirming wireless connection and cancelling specified confirmation of users at the specified time.

The radio transmitter, the clock chip, the connection detector, the control keys, the sound maker, the vibrator, the control box light-emitting device, and the position balance sensor are connected with the central control chip.

The sub-controller is integrated with the sub-control chip and the sub-connection detector; the sub-control chip is directly or indirectly connected with the central controller of the main control box and receives the instruction from the central controller later, the sub-control chip can analyze information of the detection device and transmit to the central controller and also can control the medicine box light-emitting device on the bottom of the medicine bin; the sub-connection detector is used for detecting whether other sub-medicine boxes are connected with it or not, and detection information of the sub-connection detector is transmitted to the central controller through the sub-control chip after analyzed.

The right connector of each sub-medicine box has a switch for controlling a power source connected to the sub-medicine box on its right side. When the main control box is connected with several sub-medicine boxes, the sub-controller of the first sub-medicine box connected with the main control box applies to the central control chip for a unique marker that is used for marking the first sub-medicine box. After getting the address, the first sub-medicine box turns on the switch of its right connector, and the right connector is connected with the left connector of the second sub-medicine box. After powered on, the second sub-medicine box applies to the main controller for the address, and its right connector's switch is turned on after receiving the address. Switches of the other sub-medicine boxes are turned on similarly. In this way, the other sub-medicine boxes can only apply for the addresses after the former sub-medicine box is distributed with the address, and logic of the sub-medicine boxes is guaranteed to be consistent with physical connection orders.

The detection device is an infrared transmitter and an infrared receiver or a pressure sensor; the infrared transmitter is mounted on the bottom of the medicine bin, and the infrared receiver is mounted on the top of the corresponding medicine bin or under the box cover, or vice versa; the pressure sensor is arranged on the bottom of the medicine bin.

The intelligent terminal is provided with a management system, and the management system comprises a wireless connection module, a user interface module, a medicine type database, a medicine box information synchronizing module, a medicine-taking reminding module and a medicine-taking state recording module;
the wireless connection module is used for searching the main control box of the designated intelligent extension medicine box system and is connected with the radio transmitter on the main controller through radio signals.

The user interface module is used for inputting and outputting interface and displaying. Medicine-taking type and time could be input and selected through the touch screen of the intelligent terminal, and the sub-medicine boxes are filled with specified medicine as instructed by the intelligent terminal through graphic interface;
the medicine type database is preset for option, and can be updated through the application server and store new medicine as required by users;
the medicine box information synchronizing module is used for recording medicines in the medicine bins of the sub-medicine boxes, synchronizing monitoring records of the medicine state in the medicine bins, and reminding users of refilling the medicine according to settings;
the medicine-taking reminding module is used for reminding users according to preset medicine-taking time, displaying the specified sub-medicine boxes where to-be-taken medicine is located through graphs, transmitting information to the intelligent extension medicine box system, and showing users the specified medicine bin through the medicine box light-emitting device of the sub-medicine box;
the medicine-taking state recording module is used for recording medicine-taking time and other information and transmitting the records to the assigned address through the wireless connection module.

The wireless connection module could be a 2.4G wireless module or a Bluetooth module of the intelligent terminal, and the Bluetooth module could use the low-consumption 4th generation technology.

The medicine bins are made of transparent or semi-transparent materials, the box body of the sub-medicine box is made of opaque materials, and the box cover is made of transparent or semi-transparent materials.

The medicine box light-emitting device is a light-emitting diode.

The intelligent extension medicine box system has the advantages that: the intelligent extension medicine box allows a user to assemble or disassemble the sub-medicine boxes according to needs. For each sub-medicine box has the same structure and the function, the user only needs a main control box and buys a certain number of sub-medicine boxes. In doing so, the user can feel convenient. The medicine box detects the medicine state inside in real time and information can be transmitted to the intelligent terminal. The intelligent terminal informs the user of medicine taking time and type in time through setting. With simple operation, the medicine box is applicable to all groups of people and helps medical specialist to monitor patients' medicine taking process and improve their therapy.

### BRIEF DESCRIPTION

Some of the embodiments will be described in detail, with reference to the following figures, wherein like designations denote like members, wherein:

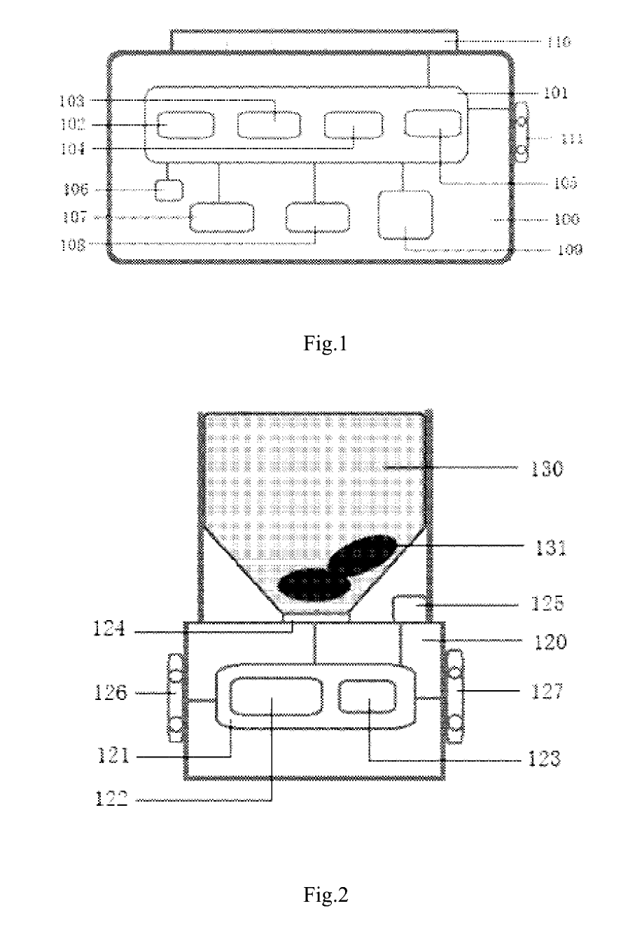

FIG. 1 is the schematic view of the main control box of the intelligent extension medicine box system.

FIG. 2 is the schematic view of the sub-medicine box of the intelligent extension medicine box system.

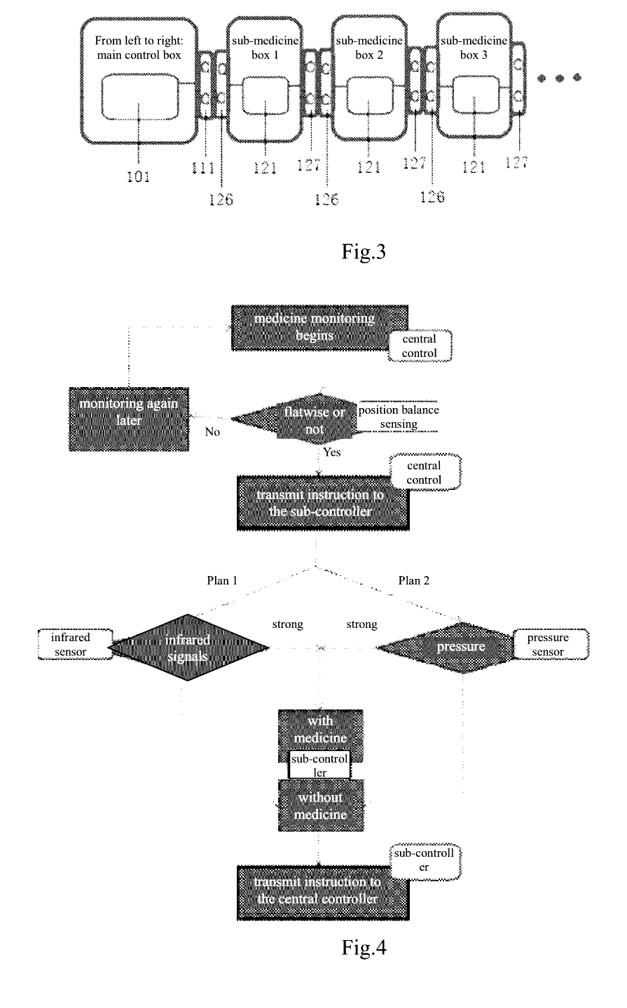

FIG. 3 is the logic view of the connection system of the main control box and the sub-medicine boxes of the intelligent extension medicine box system.

FIG. 4 is the logic view of the medicine monitoring system of the medicine bins.

### DETAILED DESCRIPTION

In the following detailed description, reference is made to the accompanying drawings and the embodiments.

FIG. 1 shows the main control box 100 of the intelligent extension medicine box, the main control box 100 is provided with control keys 110 on its upper surface and a main connector 111 on one side, and a central controller 101, a sound maker 106, a vibrator 107, a position balance sensor 108, and a control box light-emitting device 109 are arranged inside the main control box 100. The central controller 101 is connected with the sound maker 106, the vibrator 107, the position balance sensor 108, and the control box light-emitting device 109.

The central controller 101 is integrated with a central control chip 102, a radio transmitter 103, a clock chip 104, and a connection detector 105.

The radio transmitter 103 is used for connecting the medicine box with the intelligent terminal like the smart cellphone through wireless data transmission.

The connection detector 105 is used for detecting whether the sub-medicine boxes are connected with the medicine box or not.

The sound maker 106, in the form of a sound-making buzzer, is used for making sound to remind users of taking medicine at a specified time or to remind users as wireless connection is off.

The vibrator 107 is used for reminding users of taking medicine at a preset time or prompting when wireless connection is disconnected through vibration.

The position balance sensor 108 is used for sensing whether the medicine box is leveled or not and transmitting to the controller in the medicine box, so as to check medicine and usage.

The control box light-emitting device 109, in the form of a light emitting diode, is used for indicating connection and disconnection states of wireless connection and prompting users of low battery or replacement or charging the battery.

The control keys 110 are mounted on the upper surface of the main control box 100 and connected with the central controller 101, and are input devices used for confirming wireless connection and cancelling specified confirmation of users at the specified time.

The connector 111 is mounted on the right side of the main control box 100 and connected with the central controller 101. It sets up connection with the left connector, and serves as a device for fixing connection between the main control box and the sub-medicine boxes, an accessory helping the central controller detect the connection state of the sub-medicine boxes, and a bridge linking data communication between the central controller and the sub-controllers of the sub-medicine boxes.

FIG. 2 shows the sub-medicine box of the intelligent extension medicine box. The sub-medicine box consists of the box body and the box cover. The inner part of the box body is divided into a medicine storage chamber 130 and a sub-control chamber 120 from top to bottom. A medicine bin 131 with an inverted semi-conical bottom is arranged in the medicine storage chamber 130, wherein a medicine box light-emitting device 125 and a detection device 124 are arranged on the bottom of the medicine bin 131. A sub-controller 121 is arranged in the sub-control chamber. A left connector 126 and a right connector 127 are arranged at the left side and the right side of the sub-control chamber 120 respectively.

The sub-controller 121 is integrated with a sub-control chip 122 and a sub-connection detector 123. The sub-control chip 122 is directly or indirectly connected with the central controller 101 of the main control box through the left connector and then receives the instruction from the central controller 101. The sub-control chip 122 transmits information from the detection device 124 to the central controller 101 after analyzing it, and controls the medicine box light-emitting devices 125 at the bottom of the medicine bins. The sub-connection detector 123 is used for detecting whether the other sub-medicine boxes are connected with it or not. The sub-control chip 122 can transmit the detection information of the sub-connection detector 123 to the central controller 101 after analyzing it.

Each medicine bin 131 has an inverted semi-conical bottom, so as to ensure that medicine in the medicine bin will firstly fill up the bottom area due to gravity and there is enough space in the medicine bin for storing different medicines that common users take each time when the medicine box is horizontally arranged. Each medicine bin 131 is made of materials that are semi-transparent and hygienic, so that the medicine inside can be poured into a hand and taken directly.

The detection device 124 is arranged at the bottom of the medicine storage chamber 130 and used for detecting the medicine state in the medicine bins 131. The detection device can be an infrared sensor, or a pressure sensor.

The medicine box light-emitting device 125 is arranged in the sub-control chamber 120 and near the bottom of the medicine bins 131, generally in the form of the light-emitting diode, and is used for prompting users of refilling or taking medicine into the specific medicine bin. The medicine bins are made of transparent or semi-transparent plastic, the box body of the sub-medicine boxes is made of opaque materials, and the box covers are made of transparent or semi-transparent materials, so that the users can easily see the light-emitting diode through the medicine bins.

The left connectors 126 are arranged on the left sides of the sub-medicine boxes and are directly connected with the main control box or indirectly connected with the main control box through the right connectors 127 of the sub-medicine boxes connected with the main control box.

The right connectors 127 are arranged on the right sides of the sub-medicine boxes and are connected with the left connectors 26 of the other sub-medicine boxes, as the bridge linking the other sub-medicine boxes with the main control box. The sub-controller 121 controls the power source of the sub-medicine box on the right side through the right connectors 127. The sub-controller 121 detects whether or not there are sub-medicine boxes connected on its right side through the right connectors 127.

FIG. 3 shows the logic view of the connection system of the main control box and the sub-medicine boxes of the intelligent extension medicine box system. As shown in FIG. 3, the leftmost side of the main control box is provided with the only one main control box, and the right side of the main control box is connected with one or more sub-medicine boxes. To realize this, the right side of the main control box is provided with a connector connected with the left connector of one of the sub-medicine boxes, and the right side of one sub-medicine box is provided with the right connector connected with the left connector of another sub-medicine box. In this way, the sub-medicine boxes can be connected together from left to right, and at last all the sub-medicine boxes can be directly or indirectly connected with the main control box through a wired circuit.

As the sub-medicine boxes are connected to the main control box one by one, each sub-medicine box can communicate with the main control box one by one through a wired data transmission protocol according to the connection sequence. Therefore, the main control box can acquire the number and the sequence of the sub-medicine boxes connected, so as to communicate the medicine box and the specific sub-medicine box precisely. The specific embodiment is described as follows.
(1) The right connector of each sub-medicine box has a switch for controlling the power supply of the sub-medicine box connected on its right side, and the power supply switch on the right connector is turned on only when the sub-medicine box applies for the address from the main control box successfully;
(2) when the first sub-medicine box is connected with the main control box, its sub-controller applies the unique marker (hereinafter refers as address) to the central controller 101 of the main control box for marking the sub-medicine box, and the switch of the right connector the sub-medicine box is turned on after the address is received;
(3) when the second sub-medicine box is connected with the main control box, its left connector is connected with the right connector of the first sub-medicine box, as the switch power supply of the first sub-medicine box is turned on, the second sub-medicine box is powered on, and the sub-controller of the second sub-medicine box applies the address to the main control box, and the switch of the right connector of the second sub-medicine box is turned on after the address is successfully received;
(4) and so on, the subsequent sub-medicine boxes can only be powered on and apply the addresses when the former sub-medicine boxes are distributed with the addresses.
(5) the central controller 101 of the main control box will record the addresses of the sub-medicine boxes and the physical connection sequence of all the sub-medicine boxes from left to right after successfully distributing the address to each sub-medicine box. All the sub-medicine boxes carry their addresses during data transmission between the main control box and the sub-medicine boxes, so that the main control box can communicate with the sub-medicine boxes with the designated addresses;
(6) each sub-medicine box will transmit the distributed address when taking the initiative to communicate with the main control box, so the main control box can clearly acquire which one of the sub-medicine boxes communicates with it.

In order to make sure normal operation of the integral intelligent extension medicine box system, the main control box and each sub-medicine box can detect whether or not there is a sub-medicine box connected on their right sides, so as to decide whether to disassemble the sub-medicine boxes. The specific embodiment includes:
(1) the main control box judges whether or not there is a sub-medicine box connected on the connector 121 through the connection detector 105, in a way that high level shows if no sub-medicine box is connected, and low level shows if there is sub-medicine boxes connected, or vice versa;
(2) the sub-medicine box judges whether or not there are other sub-medicine boxes connected on the right connectors 127 through the sub-connection detector 123, in a way that high level shows if no sub-medicine box is connected, and low level shows if there is sub-medicine boxes connected, or vice versa.

The intelligent extension medicine box system can handle the case that one or several sub-medicine boxes are accidentally detached.
The specific embodiment includes:
(1) when one or more sub-medicine boxes are detached from the medicine box system, that means all sub-medicine boxes have been detached if detachment occurs between the main control box and the first sub-medicine box, so that the main control box can detect that no sub-medicine boxes are connected using the connection detector through the connectors;
(2) if detachment does not occur between the main control box and the first sub-medicine box, this means that there are sub-medicine boxes still connected, and then the rightmost sub-medicine box can detect detachment of the sub-medicine box using the sub-connection detector through the right connector, and transmits the instruction to the main control box;
(3) after the main control box acquires that the sub-medicine boxes are detached, the main controller notify the intelligent terminal to remind users through the radio transmitter.
   FIG. 4 shows the logic view of the medicine monitoring system of the medicine bins. As shown in FIG. 4, when the medicine box receives the instruction of the intelligent terminal or the instruction is sent at the preset time, the medicine box confirms whether to detect the medicine state of the sub-medicine boxes by analyzing information of the position balance sensor 108, and the detection method is to transmit the instruction to the sub-controllers 121 of the sub-medicine boxes. The sub-controllers 121 monitors whether medicines in the medicine bins are taken or not through the infrared sensors or pressure sensors preset in the sub-medicine boxes after receiving the instruction, notifies the central controller 101, and then transmits the information to the intelligent terminal for synchronous processing through the radio transmitter.

Each medicine bin in the sub-medicine boxes has an inverted semi-conical bottom, so as to make sure that medicine first covers the bottom center area when the medicine box is horizontally set, and to improve accuracy of the subsequent medicine monitoring. The detailed embodiment is:
(1) the central controller 101 first activates the position balance sensor 108 in the medicine box to detect whether the medicine box is horizontally placed or not;
(2) if the medicine box is horizontally placed, the medicine inside the medicine box basically stay at the bottom of the medicine box. The central controller 101 communicates with the sub-medicine boxes one by one from left to right, and transmits the instruction to the sub-controllers 121 of the sub-medicine boxes for monitoring the medicine state;
(3) the sub-controllers 121 start activating the infrared transceiving device, and judges whether or not each medicine bin is empty according to blocking degree of infrared scanning light;
(4) another detection way is to measure by the pressure sensor. Whether the medicine bins are empty or not is detected through the pressure and weight sensor at the bottom of each medicine bin, and the high-precision sensors can detect the weight of medicine precisely;
(5) information detected by the sub-controllers 121 is transmitted to the central controller 101 of the intelligent medicine box and wirelessly uploaded to the intelligent terminal to record the empty/full state of the medicine bins of each sub-medicine box monitored at fixed time and set the medicine taking requirements. In addition, weight of the medicine in the medicine bins monitored by the high-precision sensor can be used for checking type and content of the medicine preset by the intelligent terminal, so as to make medicine arrangement accurate, and avoid mistaken taking, overdose and the like caused by misoperation.

The main control box and the sub-medicine boxes are powered by two batteries, and can work for more than three months.

The intelligent terminal is provided with a management system. The management system comprises a wireless connection module, a user interface module, a medicine type database, a medicine box information synchronizing module, a medicine-taking reminding module and a medicine-taking state recording module, wherein the wireless connection module is used for searching the main control box of the designated intelligent extension medicine box system and is connected with the radio transmitter on the main controller through radio signals; the user interface module is used for inputting and outputting interface and displaying. Medicine-taking type and time could be input and selected through the touch screen of the intelligent terminal, and the sub-medicine boxes are filled with specified medicine as instructed by the intelligent terminal through graphic interface; the medicine type database is preset for option, and can be updated through the application server and store new medicine as required by users; the medicine box information synchronizing module is used for recording medicines in the medicine bins of the sub-medicine boxes, synchronizing monitoring records of the medicine state in the medicine bins, and reminding users of refilling the medicine according to settings; the medicine-taking reminding module is used for reminding users according to preset medicine-taking time, displaying the specified sub-medicine boxes where to-be-taken medicine is located through graphs, transmitting information to the intelligent extension medicine box system, and showing users the specified medicine bin through the medicine box light-emitting device of the sub-medicine box; the medicine-taking state recording module is used for recording medicine-taking time and other information and transmitting the records to the assigned address through the wireless connection module.

The intelligent medicine box and the intelligent terminal transmit data through wireless connection to download the medicine taking time preset by the intelligent terminal to the medicine box. Information about medicine and usage in the medicine bins of the medicine box can be uploaded to the intelligent terminal for analysis.

The intelligent terminal is preset with application programs controlling the intelligent medicine box. Firstly, the application programs of the intelligent terminal start searching the designed intelligent medicine box wirelessly such as Bluetooth, and sets up connection and binding. Secondly, the application programs of the smart cellphone starts settings of the medicine box, including medicine selection, medication, refilling of the medicine box and confirmation, setting of medication time, and confirmation download of medication time to the intelligent medicine box control chip. After setting, the users can determine which medicine box to be bound with the cellphone, and when going out, the users have to carry the cellphone and the medicine box together so as to avoid forgetting to take medicine and loss. The users can easily bind their cellphones with the medicine box, this generally helps the third party to set for the patients who completely depends on the prompting function of the intelligent medicine box. The volume of the intelligent medicine box can be adjusted according to actual needs (three days, a week or longer).

After setting, operation can be:
(1) when the intelligent terminal and the intelligent medicine box are bound,
a) when the intelligent terminal goes far away from the intelligent medicine box of embodiments of the invention and out of the wireless connection range (10-30 meters by the low-consumption Bluetooth technology generally used), the intelligent terminal and the intelligent medicine box make tweeting sound to remind the users of loss of their smart cellphones or the medicine box. As such, the users can take action immediately to find back their lost belongings.
b) When the users fail to find the intelligent terminal or the intelligent medicine box, both of them are kept within the wireless connection range, the users can click the search key of the application program in the intelligent terminal to activate the tweeting sound of the intelligent medicine box, in this way, the users can trace the sound to locate the medicine box. On the contrary, the users press the search key (physical key) of the intelligent medicine box to locate the intelligent terminal bound with the medicine box.
2. Medicine arrangement and medicine taking reminding can be:
a) when the users are to store the medicine, the intelligent terminal will help the users according to the input medicine taking prescription. This function includes display of the medicine box on the terminal screen, and flash of the specified medicine bins (controlled by the light-emitting diodes under the medicine bins), such that the users can accurately store the medicine into the medicine bins. At the same time, medicine type and dosage of once taking will be displayed on the intelligent terminal for reference.
b) At the time of medicine taking, the intelligent medicine box and the intelligent terminal (if bound) will make tweeting sound simultaneously to remind the users of taking medicine. The intelligent terminal displays dosage, instruction, medicine type and color, and others to avoid mistaken taking.
c) Meanwhile, the medicine bin where the medicine to be taken will emit light through the light-emitting diode at its bottom, so as to notify the users to take the medicine from the right medicine bin. This function will show in the notification of the intelligent terminal.
d) The users only need to click and confirm that the medicine has been taken after taking the right medicine (from the right medicine bin in the medicine box, and noted by a label set when in medicine refilling), and the terminal application will record the medicine taking time.
c) the users can input other information, the application of the intelligent terminal will provide memo items so as to record the medicine taking condition, such as heartbeat records, blood pressure records, weight records etc.

The intelligent terminal can sufficiently use the Internet service to have additional functions, such as:
1. the users themselves or the trusty family members can assist in setting time;
2. medication instruction can send through the doctor prescription system;
3. medication records can be directly imported into doctors' records in favor of overall examination of the doctors through information interaction between the network of the intelligent terminal and the server;
4. pharmacies can help the users manage the medicine taking records, reminding users of updating medicine, and others by uploading the detection information.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. An intelligent extension medicine box system, comprising:
a main control box and more than one sub-medicine box;
a main controller is-arranged in the main control box, wherein a main connector is arranged on one side of the main control box, and the main controller is connected with the main connector;
the sub-medicine boxes each include of a box body and a box cover, wherein the inner part of the box body is divided into a medicine storage chamber and a sub-control chamber from top to bottom;
a medicine bin with an inverted semi-conical bottom arranged in the medicine storage chamber, wherein a medicine box light-emitting device and a detection device arc arranged on the bottom of the medicine bin, and wherein the detection device is used for detecting the medicine state in the medicine bin;
a left connector and a right connector arranged at the two sides of the sub-control chamber, wherein the left connector can be connected to the main control box or the right connectors of other sub-medicine boxes through the main connector; and
a sub-controller arranged in the sub-control chamber, for controlling the detection device and the medicine box light-emitting device and transmitting analyzed information of the detection device to the main controller as connected with the main connector through the sub-connector.

2. The intelligent extension medicine box system according to claim 1, wherein the main controller is integrated with a central control chip, a radio transmitter, a clock chip, and a connection detector; a sound maker, a vibrator, a control box light-emitting device, and a position balance sensor are arranged in the main control box; control keys arranged on the upper surface of the main control box;
wherein the central control chip receives instruction from an intelligent terminal after being connected with the intelligent terminal through the radio transmitter and controls the sound maker, the vibrator, and the control box light-emitting device as instructed; and wherein the analyzed states inside the medicine box are transmitted to the intelligent terminal through the radio transmitter; the radio transmitter is used for connecting the medicine box with the intelligent terminal using radio data transmission; wherein the medicine box can be connected with the intelligent terminal and bound with the device through radio WiFi data transmission or Bluetooth;
wherein the real-time clock chip as the prompting device is in sync with current time and medicine-taking prompting time of the intelligent terminal, and can independently keep timing to help the medicine box control chip remind users;
wherein the connection detector is used for detecting if there are sub-medicine boxes connected with the medicine box;
wherein the sound maker, in the form of a sound-making buzzer, is used for making sound to remind users of taking medicine at a specified time or to remind users as wireless connection is off;
wherein the vibrator is used for reminding users of taking medicine at a preset time or prompting when wireless connection is disconnected through vibration;
wherein the control box light-emitting device, in the form of a light emitting diode, is used for indicating connection and disconnection states of wireless connection and prompting users of low battery or replacement or charging the battery;
wherein the position balance sensor is used for sensing whether the medicine box is flatwise or not and transmitting to the controller in the medicine box, so as to check medicine and content;
the control keys are input devices used for confirming wireless connection and cancelling specified confirmation of users at the specified time; and
wherein the radio transmitter, the clock chip, the connection detector, the control keys, the sound maker, the vibrator, the control box light-emitting device, and the position balance sensor are connected with the central control chip.

3. The intelligent extension medicine box system according to claim 2, wherein the sub-controller is integrated with the sub-control chip and the sub-connection detector;
the sub-control chip is directly or indirectly connected with the central controller of the main control box and receives the instruction from the central controller later, the sub-control chip can transmit information of the detection device that analyzed to the central controller and also can control the medicine box light-emitting device on the bottom of the medicine bin;
the sub-connection detector is used for detecting whether other sub-medicine boxes are connected with it or not, and detection information of the sub-connection detector is transmitted to the central controller after analyzed through the sub-control chip.

4. The intelligent extension medicine box system according to claim 3, wherein the right connector of each sub-medicine box has a switch for controlling a power source connected to the sub-medicine box on its right side when the main control box is connected with several sub-medicine boxes, the sub-controller of the first sub-medicine box connected with the main control box applies to the central control chip for a unique marker that is used for marking the first sub-medicine box; wherein after getting the address, the first sub-medicine box turns on the switch of its right connector, and the right connector is connected with the left connector of the second sub-medicine box, wherein after powered on, the second sub-medicine box applies to the main controller for the address, and its right connector's switch is turned on after receiving the address; wherein switches of the other sub-medicine boxes are turned on similarly.

5. The intelligent extension medicine box system according to claim 1, wherein the detection device is an infrared transmitter and an infrared receiver or a pressure sensor; the infrared transmitter is mounted on the bottom of the medicine bin, and the infrared receiver is mounted on the top of the corresponding medicine bin or under the box cover, or vice versa; the pressure sensor is arranged on the bottom of the medicine bin.

6. The intelligent extension medicine box system according to claim 1, wherein the intelligent terminal is provided with a management system, and the management system comprises a wireless connection module, a user interface module, a medicine type database, a medicine box information synchronizing module, a medicine-taking reminding module and a medicine-taking state recording module;
the wireless connection module is used for searching the main control box of the designated intelligent extension medicine box system and is connected with the radio transmitter on the main controller through radio signals;
the user interface module is used for inputting and outputting interface and displaying, medicine-taking type and time could be input and selected through the touch screen of the intelligent terminal, and the sub-medicine boxes are filled with specified medicine as instructed by the intelligent terminal through graphic interface;
the medicine type database is preset for an option, and can be updated through the application server and store new medicine as required by users;
the medicine box information synchronizing module is used for recording medicines in the medicine bins of the sub-medicine boxes, synchronizing monitoring records of the medicine state in the medicine bins, and reminding users of refilling the medicine according to settings;
the medicine-taking reminding module is used for reminding users according to preset medicine-taking time, displaying the specified sub-medicine boxes where to-be-taken medicine is located through graphs, transmitting information to the intelligent extension medicine box system, and showing users the specified medicine bin through the medicine box light-emitting device of the sub-medicine box;
the medicine-taking state recording module is used for recording medicine-taking time and other information and transmitting the records to the assigned address through the wireless connection module.

7. The intelligent extension medicine box system according to claim 6, wherein the wireless connection module is one of a 2.4G wireless module or a Bluetooth module of the intelligent terminal, and the Bluetooth module uses a low-consumption 4th generation technology.

8. The intelligent extension medicine box system according to claim 1, wherein the medicine bins are made of transparent or semi-transparent materials, the box body of the sub-medicine box is made of opaque materials, and the box cover is made of transparent or semi-transparent materials.

9. The intelligent extension medicine box system according to claim 1, wherein the medicine box light-emitting device is a light-emitting diode.

10. The intelligent extension medicine box system according to claim 1, wherein the intelligent terminal is a smart cellphone or tablet PC.
